(19) United States
(12) Patent Application Publication
(10) Pub. No.: US 2005/0065972 A1
(43) Pub. Date: Mar. 24, 2005

(54) Data collection in a computer network

(75) Inventors: Robert Haines, Poole (GB); Mike Jones, Hempstead (GB)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Entuity Ltd., London (GB)

(21) Appl. No.: 10/836,089

(22) Filed: Apr. 30, 2004

(30) Foreign Application Priority Data
May 2, 2003 (GB) 0310192.0

(51) Int. Cl. G06F 7/00

(52) U.S. Cl. 707/103 R

(57) ABSTRACT

A data collection system is provided for collecting data from objects in a computer network. A configuration manager reads a configuration file containing a type definition of an object associated with a stream definition for that object. The configuration file defines an object collector which is executed for collecting attribute data to create an instance of that object. The configuration file also defines a stream collector for collecting time series data from that object to instantiate the defined stream. A system, method and computer program product are described. The configuration file can alternatively or additionally include a collector definition for gathering data associated with an object in a network, with state transitions of said data being detected so that an action can be implemented based on the state transition. That action is defined in the configuration file.

### RELATED APPLICATION

This application claims priority under 35 U.S.C. § 119 or 365 to Great Britain Application No. 0310192.0, filed May 2, 2003. The entire teachings of the above application are incorporated herein by reference.

### BACKGROUND

Managers of computer networks are increasingly facing a number of challenges in optimising and managing the computer networks in their charge. Nowadays, there are a large variety of equipment and software which can be purchased, from a number of different vendors across a number of different technologies. Moreover, the rate of change in IT is ever increasing, and there is a need for computer networks to change at the same pace.

However, network managers tend to be conservative in their implementation of new networks for the reason that it is difficult to put in place proper monitoring schemes for the network and, when it is changed, it is necessary to change the monitoring scheme. Thus, although there is a wide range of new technologies available in the marketplace, their use is restricted with the result that today's networks are not necessarily optimised for the applications that they face. In recent years, for example, network managers have confronted the introduction of, among others, storage area networks (SANs), frame relay switches, virtual private network devices (VPNs), MPLS, IP multicast, layer 4 switches, VoIP switches, xDSL access technology and new classes of wireless connected devices.

At the moment, there is a long time lag between providing new network devices and new network management tools that will provide visibility into the devices. This means that where changes are made to networks, network managers must, at least for some time, live with an unoptimised network, or a network that is prone to failure for reasons that are not necessarily visible to the manager. By the time a proper network monitoring system is in place, there will be a demand to update it.

It is an aim of the invention therefore to provide a data collection system which will collect data from a wide variety of network objects in a manner which is easily adaptable to new objects being incorporated in the network.

### SUMMARY

According to one aspect of the invention there is provided a data collection system for collecting data from a plurality of objects in a computer network, comprising: a configuration manager arranged to read a configuration file containing a type definition of at least one object associated with at least one stream definition for that object; object instantiation means adapted to execute an object collector from the configuration file for collecting attribute data to create an instance of that object; stream instantiation means adapted to execute a stream collector from the configuration file for collecting time-series data from that object to instantiate the defined stream.

The data collection system described in the preferred embodiment provides a core platform for a set of services that both gather data about network devices and components (objects) in a network infrastructure, as well as store and present that data. The object instantiation means and the stream instantiation means can be implemented in a manner which is data agnostic such that the complexity of writing network and systems management applications has been abstracted to allow users to cope easily with a high level of change inherent in modern network infrastructures and to build applications fast and inexpensively.

By using a configuration file to define objects and streams, with their associated data, new classes of IT entities can be quickly incorporated into a network with the minimum of coding. To achieve this, users can build a new configuration file to manage any new device type with only a few lines of text code. This takes days, instead of months or years that hard coding would normally be required would take.

This is achievable because the configuration file defines the nature of the information which is gathered so that this is customisable via the configuration files rather than source code changes. Because the configuration file defines a type definition for objects, new objects can easily be incorporated into a network by changing the configuration file to include a new type definition for a new object. Moreover, the nature of information which is gathered can easily be altered in the configuration file by altering the stream definition which can, for example, include the poll rate for the data. So instead of writing a complex programmed executable every time there is a requirement to manage new network devices and components (objects), as would have been required in the past, users can now simply create a short, simple configuration file reflecting the attributes of the new device (object).

Another aspect of the invention provides a method of collecting data from a plurality of objects in a computer network, the method comprising: reading a configuration file containing a type definition of at least one object associated with at least one stream definition for that object; executing an object collector from the configuration file for collecting attribute data to create an instance of that object; and executing a stream collector from the configuration file for collecting time series data from that object to instantiate the defined stream.

A further aspect of the invention provides a computer program product comprising a configuration file containing a type definition of at least one object associated with at least one stream definition for that object, the configuration file being loadable into a processor operable to parse the configuration file and to generate metadata for controlling a data collection system, the configuration file further including a set of collector definitions, each collector definition including a collector name, and attribute definition and a data collection method definition.

Another aspect of the invention provides a data collection system for collecting data from a plurality of objects in a computer network, comprising: a configuration manager arranged to read a configuration file containing at least one collector definition for gathering data associated with an objection in a network; a store for holding sample values representing said data; means for detecting state transitions of said data; and means for implementing an action based on a detected state transition, said action being defined in a configuration file.

A further aspect of the invention provides a method of collecting data from a plurality of objects in a computer network, the method comprising: reading a configuration file containing at least one collector definition for gathering data associated with an object in the network; holding sample values representing said data; detecting state transitions of said data; and implementing an action based on a detected state transition, said action being defined in the configuration file.

### BRIEF DESCRIPTION OF THE DRAWINGS

For a better understanding of the present invention and to show how the same may be carried into effect, reference will now be made, by way of example, to the accompanying drawings.

FIG. 1 is a schematic architectural diagram of an embodiment of the invention;

FIG. 2 is a schematic diagram illustrating the definition of a type in a configuration file;

FIG. 3 is a schematic diagram illustrating a type hierarchy for constructing a type;

FIG. 4 is a schematic diagram of stream data tables in the database;

FIG. 5 is a schematic diagram illustrating the nature of object data and stream data;

FIG. 6 is a schematic diagram illustrating attributes and associations defined in a configuration file; and

FIG. 7 is a schematic diagram of a computer network.

### DETAILED DESCRIPTION

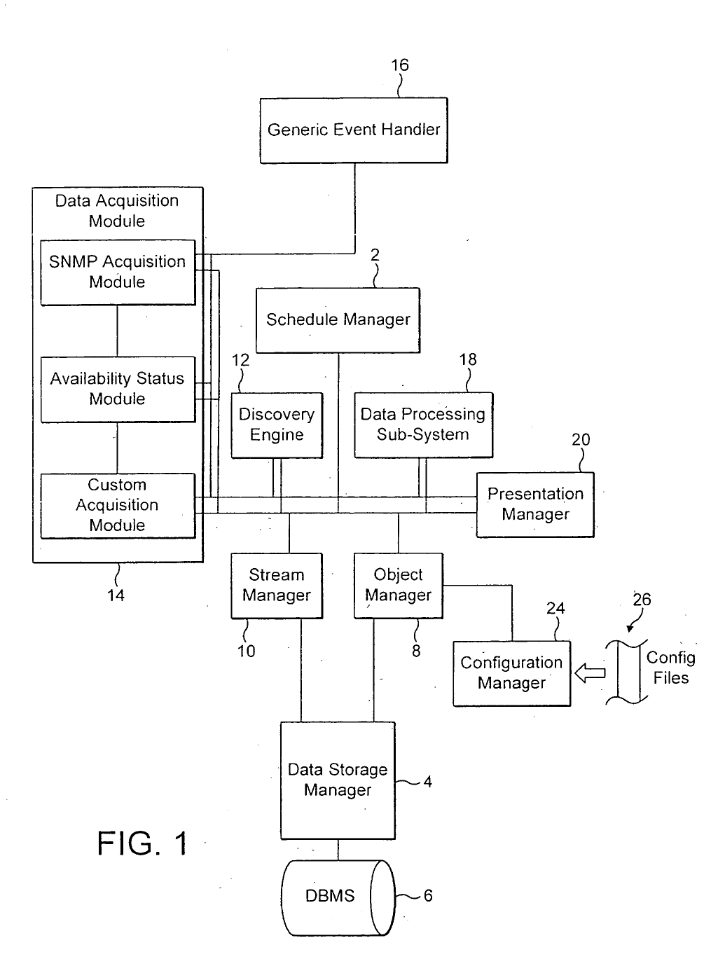

FIG. 1 is a schematic diagram of an architecture of an data collection system which allows new functionality to be delivered through a configuration file. The data collection system described herein is set up to gather data from a number of different data sources, to allow that data to be monitored. The system is particularly useful in the monitoring and management of networks comprising a plurality of interconnected devices. Network devices can include individual components, such as parts or modules which can be monitored separately. The system described herein allows a user to describe what data is to be gathered and from where, permit that data to be gathered, stores the data in a time series format in a database, extracts and processes the data in a variety of ways and generates events about changes in the data. The key feature of the data collection system described herein is that the configuration file determines, in a modifiable fashion, the features about this data gathering and processing exercise, for example the type of data polled, how it is processed, handled by the database and presented by management reports.

This is managed by a configuration manager 24 which accepts a configuration file which is denoted diagrammatically by reference numeral 26.

The configuration file 26 is parsed by the configuration manager 24 which commits resulting metadata to a database 6 after a validation stage. This metadata defines how the network is going to be monitored, and in particular defines what objects are to be checked for which streams are to be checked for and the nature of associations between objects and streams. Once the configuration file 26 has been parsed successfully, the configuration objects which are created are subject to a further round of testing before being finally committed to the database. It will be understood therefore that the configuration file 26 itself is not held in the database but is parsed by the configuration manager to generate objects, streams and collectors based on the information in the configuration file. As discussed more fully later, a collector is a code sequence which is executed to gather attribute data or stream data to instantiate objects and streams.

A data storage manager 4 controls the storage and retrieval of gathered data in the database 6. It deals with tasks such as on-the-fly creation of new data streams and the logical grouping of data streams. An object manager 8 maintains a managed object list and manages the execution of attribute collectors for instantiating objects. Object types are defined by the configuration file in a manner to be described later and are intended to represent devices connected to the network, for example ports, VLANs, switches; or components or sub-components of such network devices (e.g. files or modules). The object manager 8 gathers attribute information from these devices in a manner determined by the configuration file, and information gathered in this way by the object manager 8 is referred to herein as static object data. A stream manager 10 manages the relationship between network objects (devices) and the type of information collected from each object. The stream manager 10 also manages the execution of collectors that instantiate streams by collecting time series data referred to herein as stream data.

FIG. 1 also illustrates a schedule manager 2 which controls all periodic operations of the system using the metadata from the configuration file.

A discovery engine 12 carries out a poll of the network in the first instance to determine all of the objects from which information is to be gathered. The configuration file includes a discovery definition which allows the discovery engine 12 to automatically evaluate a network to identify devices/components attached to it which are to be specified in the database as objects with associated streams for collecting data associated with those devices. The discovery function executed on the discovery engine 12 evaluates the network to instantiate any objects of device types which exist in the network. The discovery engine 12 can thus discover and handle devices connected to a network, for example ports, modules or other devices automatically. The criteria defined in the configuration file 26 is applied to the discovered ports and devices to recognise new objects against which data can be gathered. For example, against discovered devices, object discovery polls for information related to chassis, routing and resource. Each of these types of information, and the particular data types collected, are defined through the configuration file 26. It is a big advantage of the data collection system defined herein that the data types collected from these different types of device are collected by common software, of which only the configuration differs. To collect data associated with different objects, it is only necessary to amend the configuration file 26—it is not necessary to amend the collecting software.

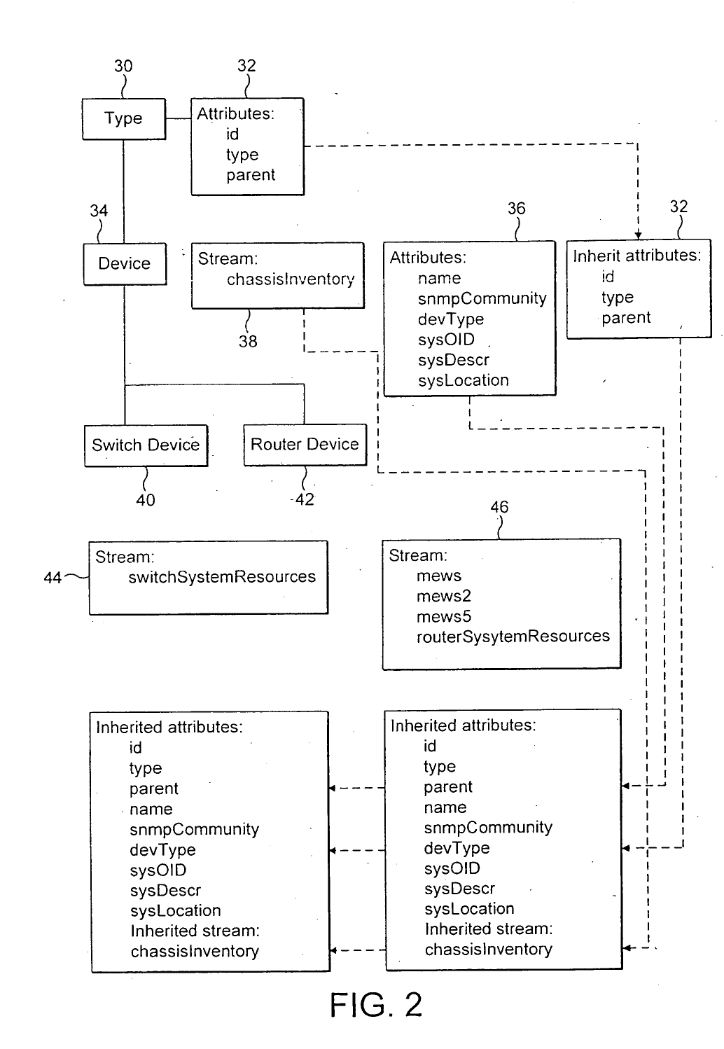

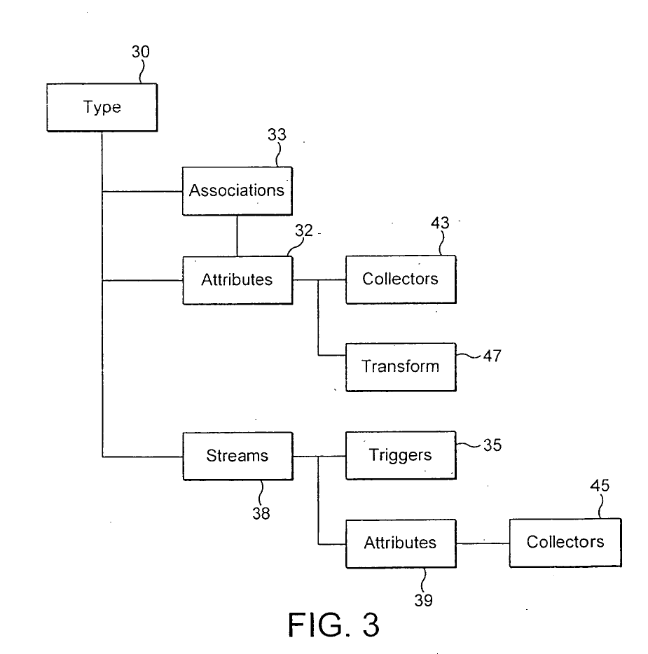

Amendment of the configuration file 26 is done using the types, streams, attributes and associations described above with reference to FIGS. 2 and 3. Methods and filters are set for these constructs so that discovered objects or the type of data returned against an object can be changed to meet user requirements.

The discovery engine forwards the list of discovered objects to the object manager 8. A set of data acquisition modules 14 perform data gathering operations from the objects. A number of different data acquisition modules can be provided, depending on the nature of devices from which data is to be gathered. Collectors are executed by a data processing sub-system 18 under the control of the schedule manager 2. The collectors specify data gathering methods and define how data is to be manipulated. For example, the collectors identify how data is collected from devices. They can also perform a degree of data roll-up using algorithms such as average, minimum, maximum and utilisation. An event handler 16 handles events raised by the system. A presentation manager 20 allows for viewing real time events and browsing objects, object attributes and their associated stream instances. As described later, object attributes define devices and can be, for example, the characteristics of a device. Object attributes are used to populate an object instance. Similarly, a stream instance is populated by stream data gathered from an object.

In order to describe the functionality of the data collection system illustrated in FIG. 1, it is necessary to understand what is meant by a type. A type configuration is set out in a configuration file 26, and used to generate an object. A type is a collection of attributes or predefined characteristics of an object. For example, chassis description, chassis firmware version and chassis backplane description are all attributes that are used in defining a chassis type. The data collection system uses type configurations to generate objects against which it can gather, process and store data. As already mentioned, these configurations are detailed in the configuration file 26. By amending the configuration file, types can be added or removed, and the characteristics of types can be changed.

New types are based on existing types, the existing type being called type. Each new type inherits the characteristics of its original, parent type and can add new characteristics to extend its scope. By extending types, definitions can be built from the general to the specific. An example of this extension is illustrated in FIG. 2. In FIG. 2, a type 30 is shown defined by its type attributes 32, in this case id, type and parent. This allows a device type to be defined as indicated by device 34 which inherits attributes 32 from the type 30 and which holds other characteristics general to devices. These include attributes 36 specific to devices, name, snmp community, devType, sysOID, sysDescr and sysLocation, and a stream definition for identifying what time-series data is to be gathered and at what frequency, in this case labelled as chassisinventory 38. The use of this device type allows sub-types to be defined and the examples given in FIG. 2 are a switch device 40 and router device 42. A network hub would be another example of a device. Each of these sub-device types inherit all of the attributes of the parent type as denoted by the dotted lines in FIG. 2 and have their individual stream types 44, 46 respectively.

Types are defined though the configuration file 26. This is a flat text file, divided into headed sections within which are the definitions for the different types, streams, attributes and other entities that are used to configure the information processing system. An example of a configuration file is given in Annex A. Also specified are the relationships between these types, for example which type extends from another or which type is associated with another. FIG. 3 illustrates a type hierarchy showing the different aspects of constructing a type 30. Held directly against a type are attributes 32, streams 38 and associations 33.

Associations define relationships between types so that information collected through different types can be tied together. For example, a device can have many ports, but a port can be associated with only one device. In both cases however the relationship needs to be established by virtue of an association 33.

Attributes 32 define data than can be polled. The attributes 32 held directly against a type imply that history data for that attribute is not required (so-called static data). Attributes 39 can also be held against a stream within a type. This is for time series data. Note that a particular attribute can be held against both a type as static data and against a stream as time series data.

Streams 38 define properties of the polling (data gathering) process. A stream can only be connected to one type, although through type inheritance it can appear otherwise. For example, referring back to FIG. 2, the stream chassisinventory is defined against the generic device type 34 and is then inherited by both the switch device and router device types 40, 42.

Types can be connected to more than one stream. For example, a port type could have two streams:
portData that records inbound and outbound octets, port speed and duplex information collected every two minutes, and
shortUtilization that records short term utilization (actually based on the octets, speed information and time stamp collected through port data) calculated every two minutes.

Triggers 35 define processing of the specified poll data from the specified stream and are not discussed further herein.

Collectors 43, 45 describe a method of how an attribute can be obtained. An attribute can have a number of collectors, which allows different methods for obtaining the same type of information. Collectors can therefore be associated with type attributes 32 (43) or stream attributes 39 (45).

A transform 47 allows data to be converted from one type to another, for example to change an integer to a string. It also allows vendor specific data which is gathered to be converted into a common format for storage.

As has already been mentioned, stream collectors define properties of the data gathering process to instantiate streams. For each object which is discovered by the operation of the discovery engine 12, a stream instance is created based on the stream attributes for that object by executing the collectors. The stream collector is used to collect time series sample data for that object.

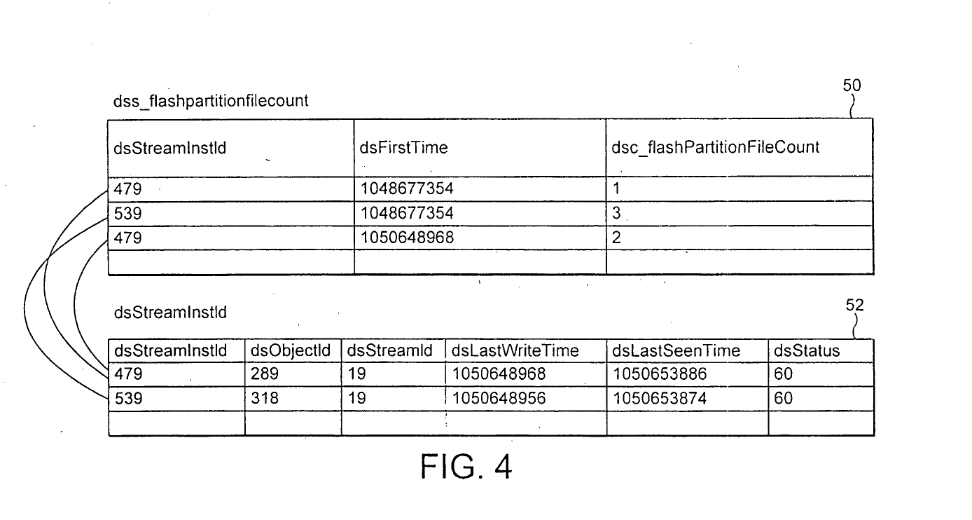

FIG. 4 illustrates the tabular structure used to hold stream instances and associated data. Each stream has associated with it a data table 50 identified by the name dss_* where * is the stream name. The example shows the stream for a file count in a flash memory partition, and the table is labelled dss_flashpartitionfilecount. Stream instances generated by the same stream specification are stored in the same table 50. These tables are created dynamically when the configuration file is parsed. Individual rows are differentiated by their stream instance ids, for example a 3-digit integer in the column named dsStreamInstld. Two examples of stream instances in the table have id numbers 479 and 539, and stream instance 479 has two rows showing two different data samples. The individual stream instance table 50 holds attribute data as it is gathered by each collector. In the example this data represents the number of files in a flash memory partition. Stream instance 479 was written once when the file count was sampled having 1 file, and subsequently a new row was written when the flash partition was sampled having 2 files. Stream instance 539 had 3 files when sampled. A column labelled dsFirstTime stores a time stamp indicating when that stream instance was first written. This allows a history of samples to be constructed from table 50.

A master-stream instance table dsStreamInst 52 connects a stream instance to a unique object, a stream and various data relating to the last time samples from this stream were collected and written to the database 6. The master table 52 holds this data for all data tables 50, though only one is shown in FIG. 4. Rows in the master-stream instance table 52 are referenced by the stream instance id from the individual stream instance table 50. An object id column in table 52 stores the object id of the object that each stream instance is connected to. A stream id column labelled dsStreamId stores the stream id of a particular stream instance. In the example shown the two stream instances 479 and 539 are instances of a stream with a stream id 19. A status column labelled dsStatus is used to specify whether pulling is enabled or disabled for each individual. The last write time and last seen time columns labelled dsLastWriteTime and dsLastSeenTime are used to store time information as will now be explained.

One of the attributes of a stream is the poll period which defines the time period between collecting successive data items from the particular object instance. The data storage manager 4 compares a captured sample with the value currently stored in the corresponding table 50 for that stream instance. When the values are different, a new row is written to the stream instance table 50, with the value in the first time column updated with the current time stamp. At the same time the columns in the master-stream instance table 52 for that stream instance are updated. The last write time column will be updated with the current time stamp to shown that the data for that stream instance in table 50 has been changed. The last seen time column is also updated with a current time stamp.

If the values are the same, then the last write time is unchanged in the master-stream instance table, but the last seen time is updated to avoid storing redundant data. No new rows are then required in table 50.

The master-stream instance table 52 therefore allows a check to be made to ascertain if a new data sample has been written, and also when a particular stream instance was last sampled.

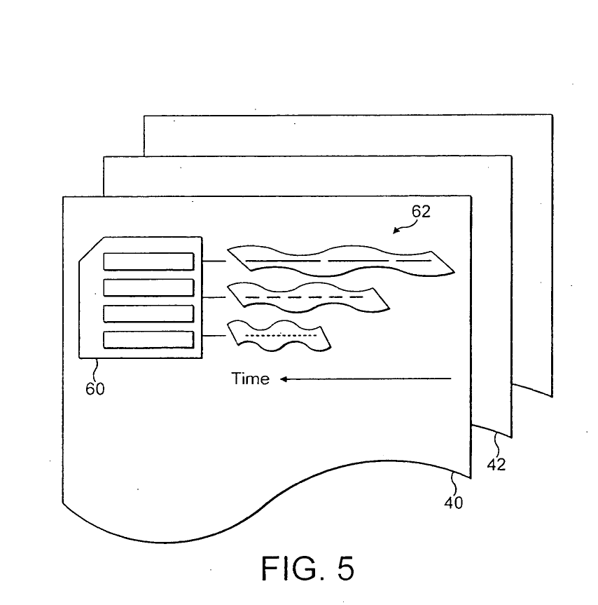

FIG. 5 is a diagram illustrating the concept of data gathering as utilised in the data collection system described herein. In FIG. 5, a plurality of objects are illustrated, for example these could be the switch device 40 and router device 42 described with reference to FIG. 2. For each object, there is static object data 60 (for which history is not important) and stream data 62 (time series data). FIG. 5 also illustrates the effect of time series data roll-up. This is one of the functions carried out by the stream manager and data processing subsystem on the basis of data acquisition method of the collector in the configuration file. That is, to avoid an excessive amount of data having to be held, data is rolled up on a time basis using functions, for example by aggregating, averaging or carrying out some other mathematical algorithm on the data. Time series data roll-up techniques are known and are therefore not described further herein.

As already mentioned, objects, streams and collectors are all defined through the configuration file 26 which is supplied to the configuration manager 24. Configuration files have the nomenclature SW_CONFIGNAME.CFG, where CONFIGNAME identifies the configuration details. Example configuration files are:
SW_CHASSIS.CFG, specifying chassis information
SW_DEVICE.CFG, specifying device management in device management functionality data.

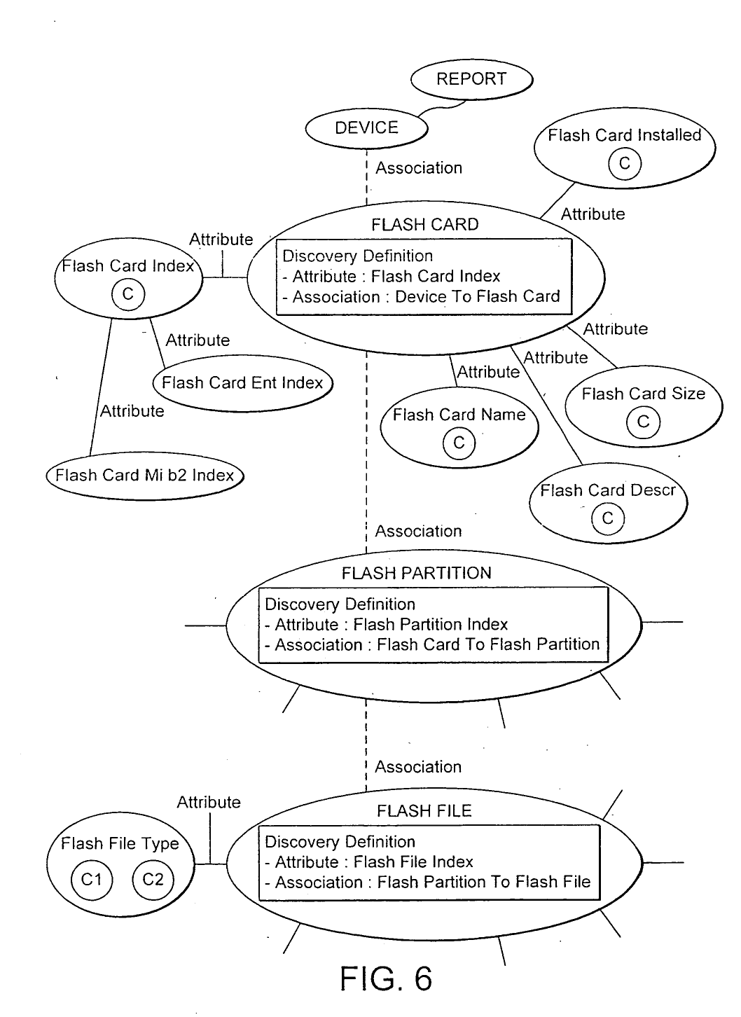

The configuration file defines attributes that enable the discovery engine 12 to discover devices and objects. In addition, it defines associations explaining the relative hierarchy between discovered objects. FIG. 6 shows an example of the associations and attributes defined in a configuration file for a flashcard memory on a device. In order to discover the flashcard, and other objects associated with it such as a partition and a file, the discovery engine 12 first evaluates discoverables for associations. Starting with an object that has already been discovered, in this example the device, each object is evaluated, and returns a list of objects associated with the parent object. In the example of FIG. 8, the associations “device To FlashCard”, “flashcard To Flash Partition” and “flash Partition To Flash File” would all be found. The discovery engine 12 then performs attribute discovery for each of the three “empty” objects. If an attribute “flash Card Index” is found for the flashcard, the flashcard is recognised as a flashcard, and collectors (labelled C) may be run for every attribute, until all attributes are populated with data.

In FIG. 6, the attribute “flash File Type” is shown to have two collectors for collecting object data or stream data. When there is more than one collection method available for an attribute, a priority level is defined in the configuration file for each collector, in order to determine the order in which data gathering methods should be tried.

Operation of the collectors will now be described in more detail. Each collector is a software implementation of a data gathering method for collecting data to populate an attribute of a type definition. Object collectors collect attribute data for populating instances of object types (to define objects which are to be monitored), and stream collectors collect data to populate stream instances, for example time series data. Collectors are generated by the configuration manager based on the configuration files 26 in accordance with the definitions given in that file, and executed by the data processing sub-system 18. Object instances are managed by the object manager 8 and stream instances are managed by the stream manager 10. Collectors are defined in the configuration file 26 using the following elements:
name—defines the name of the collector
attribute—defines the attribute which is to be populated by data gathered by this collector
method—defines the method by which data is to be collected
description—gives a text format description of the collector for display purposes
filter—determines whether the method defined for this particular collector can be used to collect data from any given object
priority—defines the priority given to this particular collector when a number of collectors are to be executed to populate the same attribute.

For object collectors 43, a transform 47 can be defined which transforms data collected for that object into a common format. That is, objects may come from a number of different vendors and have vendor specific information associated with them. Before loading data into the database, it is useful if that vendor specific information can be transformed into a common format so that objects from a number of different vendors can be understood in the same format in the database. As an example, consider status indications by objects from a number of different vendors. These can be given in a number of different formulations depending on the vendor, but the transform defined for each collector allows the data to be transformed by using different status indicators.

For example, the status indicators 0, 5, 10, 20, 30, 40, 50 can be used to identify status states okay, standby, unknown, other, minor alarm, major alarm and down respectively. In this way, collectors can build up the same object type for similar objects even if the objects come from different vendors, with slightly differing information and status indications.

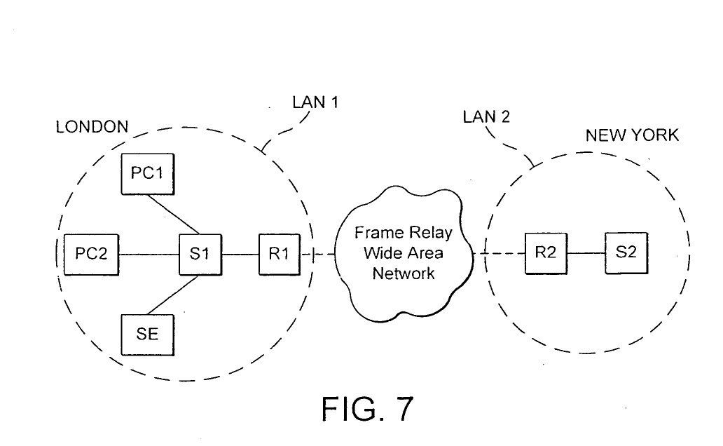

A specific implementation example will now be given. FIG. 7 is a schematic diagram of a network interconnecting remote sites London and New York. The local area network LAN1 in London is shown to comprise a switch S1, PCs PC1, PC2, a router R1 and a server SE. A frame relay wide area network WAN interconnects the router R1 with the route R2 in New York which is connected to a switch S2 of the second local area network LAN2. The information processing system described above is implemented on the server SE in London. The discovery engine 12 polls the entire network to discover objects and devices in the network, in this instance including switches S1, S2 and routers R1, R2. Starting with an object that has already been discovered (the root object on initial start-up), Discoverables are evaluated for all associated object types. Each Discoverable returns a list of objects associated with the parent object. Once objects have been discovered, attribute discovery is performed in order to populate the attributes of that object instance. Once a switch, for example switch S1, has been identified as an object, and an instance of that object type has been established for the switch, the nature of that switch can be fully determined, for example the number of its modules, blades within the modules, ports etc can be specified in the instance definition given for the switch S1 which is held in the object manager 8.

A similar exercise is carried out for the switch S2 in New York and the routers R1 and R2. In addition there may be additional hubs and ports associated with the wide area network WAN which may also be discovered by the discovery engine 12 in its initial poll.

Once an object instance has been established, its associated streams are considered and the stream tables illustrated in FIG. 4 are established, with a table for each object and a master-stream table as already described. Also, a stream collector is established for each object for the purpose of collecting time series sample data for that object. The stream instances and stream collectors are held in the stream manager 10. It will be appreciated from the foregoing description, that once the object instance has been established, the attribute collector for that object, and the stream collectors for that object are all generated automatically using the metadata parsed from the configuration file 26. Once a system has been set up in this way, the data acquisition module 14 proceeds to gather data from the located objects and return the data samples to the database as has been described. In order to instantiate a stream based on the configuration file, information concerning the data gathering is utilised, including how often data is to be polled, for how long data is to be stored, for how long should a particular stale data sample be held (for example in the event of system crash or turn off). Gathering of data by the data acquisition module 14 is accomplished in accordance with the specified information used to instantiate the stream on the basis of the configuration file. The data storage manager 4 then manages the data using roll-up or mathematical algorithm techniques.

The data collection system described herein can include configurable event state engine.

The event state engine triggers actions using a state machine mechanism. These actions are specified using a Statement Language. The actions are performed when the current state of the entity changes to a new state. These state changes are made depending on the outcome of configurable transition methods, which are also specified using the Statement Language.

For example consider port state. Port state might be split into three categories—normal, high and low. Normal means this element of the system is running normally and there is nothing to worry about. High means that this element of the system is overloaded and some action needs to be taken. Low means that this element of the system is under-utilised, which might indicate a nearby failure which is preventing traffic reaching this element.

The system starts up with each element in a starting state—called the “initial event state”. For port state this might be “normal utilization state”.

For each state there are a number of “event state transitions”. For “normal port state” these might be “normal to high utilization transition” and “normal to low utilization transition”.

A function is run over the data to determine state and monitor state transitions. Each of these transitions has a conditional statement coded using the Statement Language. Taking the example of “normal to high utilization threshold”, this might be that the utilization for this port has exceeded a “threshold value”.

Thresholds are configured to support these conditional statements. These form a hierarchy—e.g. for a port, it is possible to set a threshold for the individual port which takes precedence over a threshold for the device as a whole which takes precedence over a threshold for the system as a whole—and finally a default value. Each of these can be individually set to a value and/or disabled/enabled in the Component Viewer (in the presentations manager).

If one of the transition methods evaluates to true then the state is set to the new state indicated for this transition—e.g. for “normal to high utilization transition” this would be “high utilization event state”.

This state is recorded as the current state for the element in the database. A configurable amount of history is kept recording the various states over time for this element. This is aged out after the configured “keep time” in order to free up the space.

An action configured for the transition of state is set up using the Statement Language corresponding to the move from one state to another state.

A typical action would be to raise an alarm event for the transition to the non-nominal state and to raise a clear event for the transition back to the nominal state.

This leads to the event being seen in a Bulletin Board for clients registered to a view containing the element for which the event was generated.

A number of further actions can be configured for the raising of an event such as:
Forwarding a trap corresponding to the event to a 3rd party application.
Starting up a 3rd party application and passing it details of the event.
Sending a mail to someone.

Having now described some illustrative embodiments, it should be apparent to those skilled in the art that the forgoing is merely illustrative and not limiting, having been presented by way of example only. Numerous modifications and other illustrative embodiments are within the scope of one of ordinary skill in the art, and are contemplated as falling within the scope of the invention. For the one or more means—+—function limitations recited in the following claims, the means are not intended to be limited to the means disclosed herein for performing the recited function, but are intended to cover in scope any means, known now or later developed, for performing the recited function.

[image]

1. A data collection system for collecting data from a plurality of objects in a computer network, comprising:
a configuration manager arranged to read a configuration file containing a type definition of at least one object associated with at least one stream definition for that object;
object instantiation means adapted to execute an object collector from the configuration file for collecting attribute data to create an instance of that object;
stream instantiation means adapted to execute a stream collector from the configuration file for collecting time-series data from that object to instantiate the defined stream.

2. A data collection system according to claim 1, comprising a data acquisition unit operable to collect data under the control of the object collector and stream collector.

3. A data collection system according to claim 1, which comprises a store for holding sample values representing said time-series data in association with the defined stream.

4. A data collection system according to claim 1, wherein the type definition identifies at least one data collection method for collecting the attribute data.

5. A data collection system according to claim 1, wherein the stream definition identifies at least one data collection method for collecting the time-series data.

6. A data collection system according to claim 1, wherein the stream definition defines a polling period for collecting the time-series data.

7. A data collection system according to claim 1, wherein the stream definition defines a storage period for holding said sample values.

8. A data collection system according to claim 1, wherein the object collector and stream collector each implement a transform for converting collected data from a received format to a common format.

9. A data collection system according to claim 1, which comprises means for editing the configuration file to add, modify or remove type definitions in dependence on objects in the computer network.

10. A data collection system according to claim 1, which comprises means for editing the configuration file to add, modify or remove stream definitions.

11. A data collection system according to claim 1, comprising a user interface arranged to display reports based on the collected data.

12. A method of collecting data from a plurality of objects in a computer network, the method comprising:
reading a configuration file containing a type definition of at least one object associated with at least one stream definition for that object;
executing an object collector from the configuration file for collecting attribute data to create an instance of that object; and
executing a stream collector from the configuration file for collecting time series data from that object to instantiate the defined stream.

13. A method of collecting data according to claim 12, wherein sample values representing said time series data are held in a store in association with the defined stream.

14. A method according to claim 12, wherein the type definition identifies at least one data collection method for collecting the attribute data.

15. A method according to claim 12, wherein the stream definition identifies at least one data collection method for collecting the time series data.

16. A method according to claim 12, wherein the stream definition defines a polling period for collecting the time series data.

17. A method according to claim 12, wherein the stream definition defines a storage period for holding said sample values.

18. A method according to claim 12, which comprises the step of implementing a transform for converting collected data from a received format to a common format.

19. A method according to claim 12, comprising the step of displaying reports based on the collected data.

20. A computer program product comprising a configuration file containing a type definition of at least one object associated with at least one stream definition for that object, the configuration file being loadable into a processor operable to parse the configuration file and to generate metadata for controlling a data collection system, the configuration file further including a set of collector definitions, each collector definition including a collector name, and attribute definition and a data collection method definition.

21. A computer program product according to claim 20, wherein each collector definition includes a collector description in a text format for display purposes.

22. A computer program product according to claim 20, wherein each collector definition includes a filter for determining whether the data collection method defined in the collector can be used to collect data from any given object.

23. A computer program product according to claim 20, which includes a priority indicator which defines the priority given to this particular collector when a number of collectors for the same attribute are to be executed.

24. A data collection system for collecting data from a plurality of objects in a computer network, comprising:
a configuration manager arranged to read a configuration file containing at least one collector definition for gathering data associated with an object in a network;
a store for holding sample values representing said data;
means for detecting state transitions of said data; and
means for implementing an action based on a detected state transition, said action being defined in a configuration file.

25. A method of collecting data from a plurality of objects in a computer network, the method comprising:
reading a configuration file containing at least one collector definition for gathering data associated with an object in the network;
holding sample values representing said data;
detecting state transitions of said data; and
implementing an action based on a detected state transition, said action being defined in the configuration file.

26. A data collection system according to claim 1, wherein the configuration file defines actions to be implemented when said data identifies a transition between states, thereby raising a state event.

27. A method according to claim 12 wherein the configuration file defines actions to be implemented when said data identifies a transition between states, thereby raising a state event.

28. A computer program product according to claim 20 wherein the configuration file defines actions to be implemented when said data identifies a transition between states, thereby raising a state event.
